(19) United States
(12) Patent Application Publication
(10) Pub. No.: US 2007/0107301 A1
(43) Pub. Date: May 17, 2007

(54) Edge strip for edging plants and making in-ground plant pots

(76) Inventor: Frank J. Meyers, Evergreen Park, IL (US)

Correspondence Address: BRIAN R. RAYVE, 161 MAPLE DRIVE, PARK CITY, UT, 84098, US

(21) Appl. No.: 11/029,637

(22) Filed: Jan. 5, 2005

(51) Int. Cl. A01G 13/00

(52) U.S. Cl. 47/32.8

(57) ABSTRACT

A flexible edge strip for insertion into the ground around plants to prevent roots of the plant and the roots of surrounding plants from mixing together, methods of use and manufacture thereof. The edge strip is of a flexible C-shaped cross-section with an elongate vertical leg having opposite ends which interconnect to form a looped configuration, and top and bottom edges each with a dependent horizontal flange co-extending therealong at substantially a right angle thereto. The horizontal flanges are divided into a plurality of individual tabs separated by respective slots adapted to facilitate bending of the edge strip. The ends of the vertical leg respectively include a retaining tab and a mating vertically disposed retaining slot to receive the retaining tab therethrough to retain the retaining tab therein. The edge strip may be shortened at a plurality of perforated separation lines that extend transversely thereacross. An retaining slot is disposed adjacent each separation line to retain the retaining tab for retention of the shortened edge strip in the looped configuration. The vertical leg obstructs water outflow and root growth when inserted into the ground generally parallel to the ground surface. The horizontal flanges respectively obstruct plant growth above the ground and anchor the edge strip within the ground.

### RELATED APPLICATION

This application claims priority of my copending U.S. Provisional Patent Application No. 60/534,296 filed Jan. 4, 2004.

### BACKGROUND OF THE INVENTION

1. Field

The present invention generally relates to devices for landscaping, lawn care, and garden care, methods of use, and manufacturing processes therefor, and more particularly to edging devices, methods of use, and methods of manufacture used to conserve water for plants and prevent unwanted encroachment of vegetation.

2. State of the Art

Various landscaped areas are created on the typical home, business, golf course, or other such properties to enhance the appearance thereof. For example, a large area might be covered by a lawn, a smaller area allocated as a flower garden, areas for driveways and sidewalks, and numerous smaller areas for individual trees, bushes, flowers, and the like. Boundaries between the landscaped areas may be defined by edging such as bricks, blocks, or flexible plastic edging strips. For example, the lawn area is often separated from a flower garden by a brick curb. The area around the base of trees is often separated from the lawn in a similar manner.

Vegetation such as grass, flowers, and the like often have extensive root systems that intertwine and transfer rain and irrigation water in undesirable ways. For example, the lawn adjacent a flower garden often siphons away irrigation water intended for the flowers due to overlapping of the grass root system into the flower bed. Likewise, the grass can grow into the flower garden requiring manual edging or pulling of the overlapping grass to maintain the proper boundary therebetween.

In response to these problems, various edging devices have been patented with varying degrees of success. For example, in U.S. Pat. No. 4,281,473 issued to Emalfarb, et al. on Aug. 4, 1981 is disclosed a landscaping bed divider used to form a boundary between adjacent landscaping areas and for preventing plants from rooting between adjacent areas. The bed divider is of elongate configuration which includes an enlarged tubular upper section, a downwardly dependent corrugated section which terminates at a plane section, and respective opposite upwardly and outwardly diverging anchor flanges disposed just above the plane section. The bed divider is partially buried in the ground with the upper section disposed above the surface of the ground, the corrugated section forming a barrier to roots between adjacent landscaping areas, and the anchor flanges securing the bed divider in the ground.

While the bed divider of Emalfarb, et al. is generally adequate for the purposes intended, it has some serious shortcomings. Firstly, it is primarily intended for straight or only slightly curved boundaries between landscaping areas and not for encircling individual or small groups of plants. Secondly, it is rather complex and does not appear to be manufacturable using inexpensive plastic extrusion processes. Lastly, it has a rather large tubular upper section that obtrusively protrudes above the surface of the ground.

In U.S. Pat. No. 4,809,459 issued to Brylla, et al. on Mar. 7, 1989 is disclosed a building and garden edging of L-shaped cross-section. The edging has a first leg which is inserted into the ground and a second leg which rests on the surface of the ground to stop plants from growing such as grass to alleviate hand-trimming after the lawn is mowed with a mower. The second leg may be slit to permit bending the edging device to fit curved areas. Another version of the edging has the second leg pivotally connected thereto using a hinge material. The second leg has a tongue which is selectively engageable with a groove in the first leg to rigidly hold the second leg to the first leg. The second leg is disengageable from the groove to permit folding of the edging device. Yet another version of the edging has the second leg as a loose piece with a pair of tongues that are slidable into a dovetail groove in the first leg to permit selective use as a rigid edging and to permit rolling up thereof.

While the edging of Brylla, et al. is generally adequate for the purposes intended, it has at least one serious shortcoming. It is primarily intended for straight or only slightly curved boundaries between landscaping areas and not for encircling individual or small groups of plants.

In U.S. Pat. No. 5,067,273 issued to Richwine on Nov. 26, 1991 is disclosed a lawn edging having a top portion comprised of a tubular ridge portion and a wall downwardly dependent therefrom that terminates at a narrower flange. A base portion includes a planar base from which a pair of parallel upstanding walls are upwardly dependent in spaced relationship to closely receive the flange of the top portion to form an integrated unit. The base portion is buried in the ground such that respective ends of the upstanding walls are flush with the surface of the ground. The top portion may be removed to facilitate cutting of the lawn and replaced afterward. The ridge portion strengthens the top portion of the lawn edging to help prevent breakage thereof.

While the lawn edging of Richwine is generally adequate for the purposes intended, it has some serious shortcomings. Firstly, it is primarily intended for straight or only slightly curved boundaries between landscaping areas and not for encircling individual or small groups of plants. Secondly, it is a rather complex two-piece design likely to inadvertently separate during use. Lastly, it extends rather high from the surface of the ground and has a large tubular upper section that obtrusively protrudes above the surface of the ground.

There is a continuing need for a edging device which: 1) is designed to conform to both straight and curved boundaries between landscaping areas including encircling individual or small groups of plants and being securable in a looped configuration; 2) is a relatively simple, single-piece design that is readily manufacturable using inexpensive processes such as extrusion; and 3) is obtrusive with minimal protrusion above the surface of the ground. Additionally, the edging device needs to resist breakage and distortion due to heaving of the ground.

### SUMMARY OF THE INVENTION

The present invention is a flexible edge strip for insertion into the ground around plants to prevent roots of the plant and the roots of surrounding plants from mixing together, a method of preventing roots of plants and the roots of surrounding plants from mixing together, and a method of manufacturing plastic edge strips.

The edge strip includes an elongate, flexible vertical leg having respective first and second ends adapted to be interconnectable to each other to form a looped configuration and to adjacent edge strips to form a longer interconnected group configuration of multiple edge strips. At least one elongate horizontal flange is dependent from and co-extends along the vertical leg at an angle thereto which is divided into a plurality of individual tabs separated by respective slots adapted to facilitate bending of the edge strip. The vertical leg functions to obstruct water outflow and root growth when inserted into the ground generally parallel to a surface thereof and the horizontal flange is adapted to perform a function chosen from the group consisting of obstructing plant growth above the ground and anchoring the edge strip within the ground.

In a preferred edge strip, the vertical leg has respective top and bottom edges with each horizontal flange respectively dependent along one thereof. There are a pair of the horizontal flanges to form a C-shaped cross-section with each horizontal flange co-extending along the vertical leg at substantially a right angle thereto. The first end of the vertical leg has a T-shaped retaining tab and a longitudinally tapered retaining tab each adapted for insertion through a vertically disposed retaining slot of the second end adapted to receive the retaining tab therethrough to retain the retaining tab therein. The T-shaped retaining tab is comprised of a vertically disposed end leg and an intersecting horizontally disposed longitudinal leg. The retaining slot is of a length slightly smaller than the end leg requiring slight tilting of the retaining tab for insertion therethrough. The vertical leg has longitudinally angled edges which extend from the longitudinal leg to facilitate the tilting of the retaining tab for insertion through the retaining slot. An alternative longitudinally tapered retaining tab has the retaining slot being of a length slightly larger than a maximum height of the tapered retaining tab to allow complete insertion thereof into the retaining slot. At least one separation line extends generally transversely across the vertical leg and horizontal flanges for shortening of the edge strip to at least one predetermined shorter length. An area adjacent each separation line comprises a new second end adapted to be interconnectable to the first end of the vertical wall for retention of the shortened edge strip in the looped configuration. Each separation line extends substantially at a right angle transversely across the edge strip and is of a configuration of printed for cutting, perforated for breaking, reduced thickness for breaking, or unmarked for cutting. Each separation line extends from respective of the slots between the retaining tabs across the vertical wall.

The method of preventing roots of plants and the roots of surrounding plants from mixing together, comprises the steps of: 1) providing a flexible edge strip having opposite ends adapted to be interconnectable to each other; 2) forming the edge strip into a looped configuration by interconnecting the ends with a sufficient radius to surround the roots of the plant and securing the ends together; 3) digging a hole of a type chosen from the group consisting of a hole of sufficient to diameter and depth to accommodate the roots of the plant surrounded by the edge strip for new plants and a circular trench of sufficient to diameter and depth to accommodate the edge strip around existing plants; 4) placing the edge strip in the hole around the roots of the plant with an upper edge thereof approximately flush with an upper surface of the ground; and 5) filling in the hole around the roots and the edge strip to anchor them in the ground so the edge strip blocks the roots of the plant and the roots of surrounding plants from mixing together.

A preferred method includes an additional step of: 6) cutting the edge strip to length. The ends of the edge strip provided as cut are adapted to be interconnectable to each other to form the looped configuration. A plurality of the edge strips may be provided and the ends of adjacent edge strips interconnected to form a longer interconnected group of multiple edge strips prior to forming the group of edge strips into the looped configuration by interconnecting remaining free ends thereof. Each edge strip provided may includes an elongate vertical leg having the first and second ends and a pair of elongate horizontal flanges that are dependent from and co-extends along respective edges of the vertical leg at right angle thereto, each divided into a plurality of individual tabs separated by respective slots adapted to facilitate bending of the edge strip.

The method of manufacturing plastic edge strips comprises the steps of: 1) cutting extruded raw edge strip into the raw lengths of edge strip; 2) providing a fixture for holding at least one of the raw lengths of edge strip; 3) assembling at least one of the raw lengths of edge strip to the fixture; 4) cutting each raw length of edge strip in the fixture to a finished form; and 5) removing each raw length of edge strip in finished form from the fixture.

In a preferred process, the raw lengths of edge strip are cut to the finished form using a process such as liquid abrasive jet cutting or milling. The cutting process used may simultaneously make multiple cuttings to each of the raw lengths of the edge strip to the finished form using multiple cutting heads. The cutting process may be done in a manner of manually operated wherein one or more cutting heads is manually moved by hand to various stop positions, fully automated computer numerical controlled machines, or semi-automatic machines. The fixture may hold a plurality of the raw lengths of edge strip for simultaneous cutting to final form.

### THE DRAWINGS

The best mode presently contemplated for carrying out the invention is illustrated in the accompanying drawings, in which:

FIG. 1 is a perspective view of an edge strip in accordance with the present invention shown in an unbent condition;

FIG. 2, a top plan view of the edge strip in the unbent condition;

FIG. 3, a front elevational view of the edge strip taken on the line 3-3 of FIG. 2;

FIG. 4, a fragmentary view of the edge strip to an enlarged scale taken on the line 4-4 of FIG. 2;

FIG. 5, an end view of a first end of the edge strip taken on the line 5-5 of FIG. 3;

FIG. 6, a fragmentary front elevational view of a first end of the edge strip to an enlarge scale taken on the line 6-6 of FIG. 2;

FIG. 7, a fragmentary front elevational view of a second end of the edge strip to the enlarge scale taken on the line 7-7 of FIG. 2;

FIG. 8, a top plan view of the edge strip into a formed condition as used buried in the ground around a rose plant separating it from surrounding plants; and

FIG. 9, a fragmentary side elevational view of the edge strip taken on the line 9-9 of FIG. 8 with the ground partially broken away.

### DETAILED DESCRIPTION OF THE ILLUSTRATED EMBODIMENTS

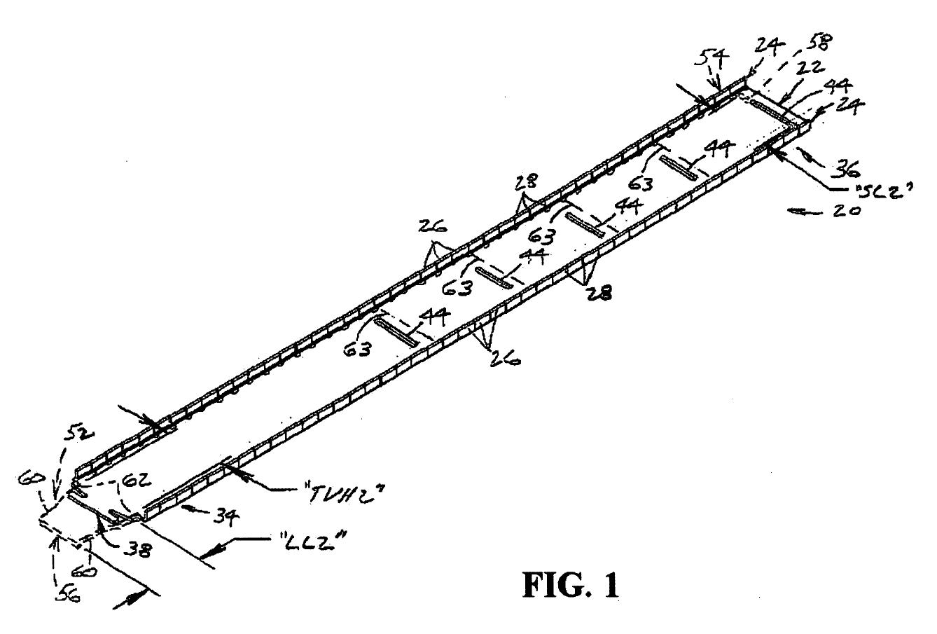

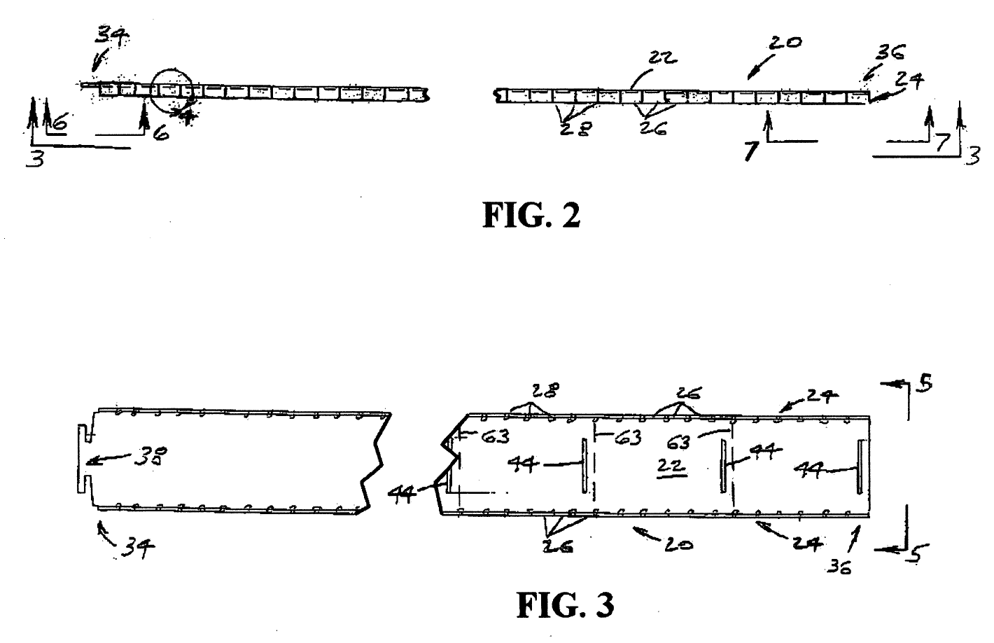

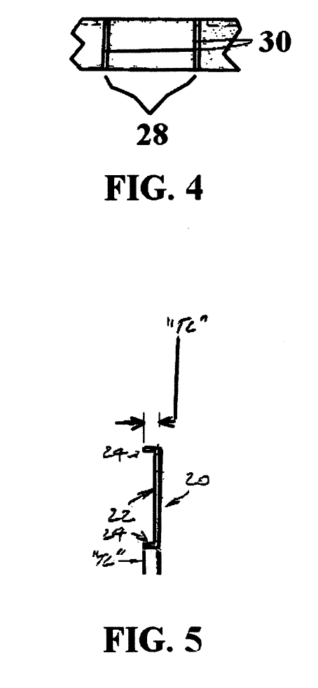

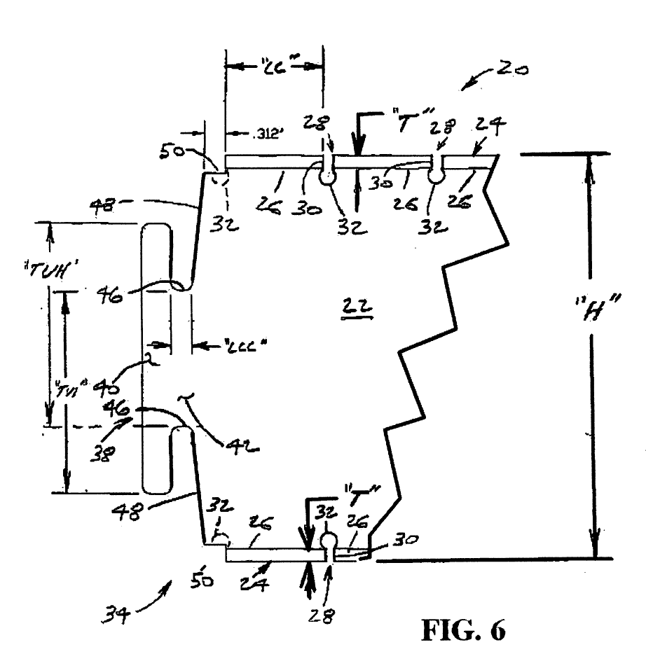

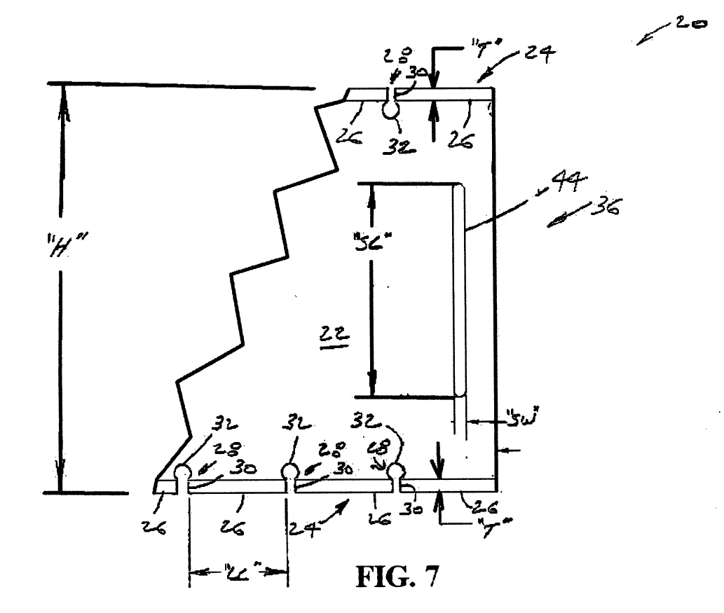

Referring to FIGS. 1-7, the present invention comprises a flexible barrier edging or edge strip, designated generally at 20, for insertion into the ground around plants to prevent roots of the plant and the roots of surrounding plants from mixing together, to retain water, and the like.

The edge strip 20 includes an elongate, flexible vertical leg 22 terminating at a pair of parallel horizontal flanges 24 dependent from and co-extending from respective top and bottom edges thereof at a right angle thereto to form a C-shaped cross-section (though other configurations such as an S-shape wherein the horizontal flanges 24 extend oppositely are also possible). The horizontal flanges 24 are divided into a plurality of individual tabs 26 separated by respective slots 28 to facilitate bending of the edge strip 20. The tabs 26 are preferably of a longitudinal length “LL” of about three-quarters inch which has been found to allow edge strip 20 to laterally bend into a satisfactory circular configuration about plants without vertical leg 22 and horizontal flanges 24 cracking or breaking. The slots 28 preferably have respective straight portions 30 through horizontal flanges 24 terminating at respective round ends 32 through vertical leg 22. Round ends 32 relieve stresses to prevent cracking of vertical leg 22 by cracks propagating from slots 28.

The edge strip 20 has respective first and second ends 34 and 36 adapted to be interconnectable to each other to form a looped configuration and to adjacent edge strips (not shown) to form a longer interconnected group configuration of multiple edge strips. The first end 34 has a T-shaped retaining tab 38 comprised of a vertically disposed end leg 40 and an intersecting horizontally disposed longitudinal leg 42 preferably cut out from vertical leg 22 and horizontal flanges 24. The second end 36 has a vertically disposed retaining slot 44 which receives the retaining tab 38 therethrough to vertically and longitudinally retain the retaining tab 38 therein. Retaining slot 44 is of a slot length “SL” and a slot width “SW”. The slot length “SL” is slightly smaller than a tab vertical height “TVH” measured vertically from longitudinal leg 42 to one or the other opposing edges 46 of longitudinal leg 42 and the slot width “SW” is slightly greater than thickness “T” to allow insertion of the retaining tab 38 into retaining slot 44 by requiring slight tilting of the retaining tab 38 for insertion therethrough and straightening by untilting to lock therein. To facilitate tilting of retaining tab 38 for insertion of end leg 40 through slot 44, the vertical leg 22 has respective longitudinally angled edges 48 which extend from the longitudinal leg 42 to respective cutouts 50 removed from vertical leg 22 and horizontal flanges 24. Longitudinal leg 42 is of a longitudinal length “LLL” such that when the first and second ends 34 and 36 are assembled together, the straight portions 30 of slots 28 are formed from portions of cutouts 50. The position where the round ends 32 of slots 28 would be through vertical leg 22 are shown in dotted lines for reference. The round ends 32 may be added or cutouts 50 rounded to relieve stresses to prevent cracking of vertical leg 22 by cracks propagating from cutouts 50.

The edge strip 20 (i.e. vertical leg 22) perferably has a height “H” of between about five and six inches to prevent the roots rhizomes from growing therebelow, most preferably about five and one-half inches which has been found suitable for most applications. Each horizontal flange 24 is preferably of a width or transverse length “TL” preferably of a width of between about one-half inch and one inch, most preferably about three-quarter inch which has likewise been found suitable for most applications. The dimensions described herein and shown on the accompanying figures are for illustration and may be changed as needed to suit the particular application, depending primarily of the root depth of the particular plants it is used with. Horizontal flanges 24 may be of two different transverse lengths if so desired, for example a topmost thereof being longer than a bottommost thereof.

The vertical leg 22 and the horizontal flanges 24 are preferably integrally molded from a plastic material such as polyvinyl chloride, polyethylene, or polypropylene which resist degradation such as discoloration and brittleness due to water, sunshine, fertilizers, weed killers, and the encountered during use. Conventional coloring pigments, ultraviolet resistant agents, and other additives may be used as required for the particular use. Preferably the edge strip 20 is initially extruded from the plastic material with the vertical leg 22 and the horizontal flanges 24 of a substantially equal constant thickness “T” of between about one-sixteenth inch and one-quarter inch which allows bending yet is durable. The edge strip 20 is then preferably cut to final shape as discussed below. The edge strip 20 may also be injection molded from plastic, or made using other suitable materials and manufacturing processes.

In an alternate design for edge strip 20 shown in FIG. 1, there are interconnectable first and second ends 52 and 54 (dotted lines). The first end 52 has a retaining tab 56 which is longitudinally tapered, preferably cut out from vertical leg 22 and horizontal flange 24. The second end 54 has a vertically disposed retaining slot 58 which receives the retaining tab 56 therethrough to vertically retain the retaining tab 56 therein. Retaining tab 56 is longitudinally tapered, being cut at opposing longitudinally angled edges 60 which extend to respective enlarged cutouts 62 removed from vertical leg 22 and horizontal flanges 24 (dotted lines) to facilitate insertion of tab 56 through slot 58. Retaining slot 58 is of a slot length “SL2” slightly larger than a maximum tab vertical height “TVH2” of retaining tab 56 which extends vertically between angled edges 60 at vertical leg 22 to allow complete insertion thereof into the retaining slot 58. Retaining tab 56 is of a longitudinal length “LL2” such that when the first and second ends 52 and 54 are assembled together, the straight portions 30 of slots 28 are formed from portions of cutouts 62. The position where the round ends 32 of slots 28 would be through vertical leg 22 are shown in dotted lines for reference. The round ends 32 may be added or cutouts 62 rounded to relieve stresses to prevent cracking of vertical leg 22 by cracks propagating from cutouts 62.

Edge strip 20 may be made to accommodate a plurality of predetermined adjustable lengths by including a plurality of the vertically disposed retaining slots 44 or 58 spaced in the same relationship to retaining tabs 26 as shown for the single retaining slots 44 or 58. A plurality of cutting or separation lines 63 are disposed at a right angle transversely across the edge strip 20 including the vertical leg 22 and horizontal flanges 24 for shortening of the edge strip 20 to a plurality of predetermined shorter lengths. Respective areas adjacent each separation line 63 comprises a new second end with the retaining slots 44 or 58 which are interconnectable with the first end 34 of the vertical wall 22 for retention of the shortened edge strip (not shown) in the looped configuration. Each separation line 63 preferably extends from respective of the slots 28 between the retaining tabs 26 across the vertical wall 22. The separation lines 63 may be printed for cutting, perforated for breaking, reduced thickness for breaking, unmarked for cutting (i.e. the retaining slots 44 or 58 indicate where cutting should be done), or the like to facilitate cutting or breaking the edge strip 20 to one of the predetermined lengths. Tab 38 or 56 inserts respectively through the slot 44 or 58 adjacent the cutting line 63 utilized for retention of edge strip 20 in a circular configuration as described above.

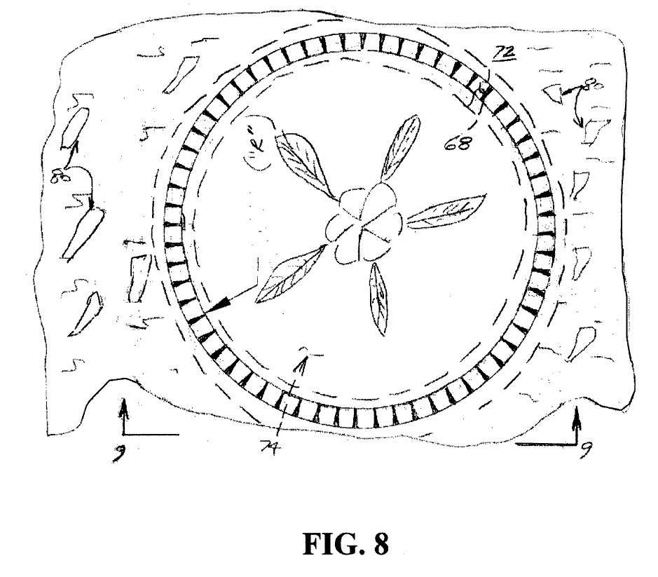

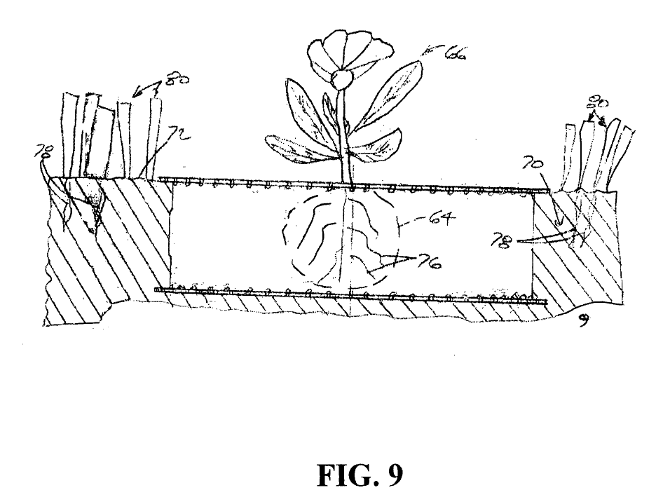

Referring to FIGS. 8 and 9, the edge strip 20 is used by providing the edge strip 20 of sufficient length or cutting to length and forming it into the circular configuration of sufficient radius “R” to surround the root ball 64 of a rose plant 66 or other plant. If the plant 66 is already planted, a circular trench 68 is dug therearound in the earth 70 of sufficient diameter and depth in which an uppermost of horizontal flanges 24 is approximately flush with an upper surface 72 of the earth 70 in which to place edge strip 20. If the plant 66 is also being planted at this time, then a circular hole 74 is dug in the earth 70 large enough to accommodate edge strip 20 and root ball 64. In either case, the respective circular trench 68 or hole 74 is filled in with removed earth, potting soil, or other growing material around the edge strip 20 and root ball 64 following placement thereof. The vertical leg 22 functions to obstruct water outflow and root growth (i.e. prevent the roots 76 of plant 66 and the roots 78 of surrounding plants 80 from mixing together) when inserted into the ground generally parallel to a surface thereof and the horizontal flanges 24 respectively function to obstruct plant growth above the ground and anchor the edge strip 20 within the ground.

A preferred method of preventing roots of plants and the roots of surrounding plants from mixing together includes the steps of: 1) providing a flexible edge strip having opposite ends adapted to be interconnectable to each other; 2) forming the edge strip into a looped configuration by interconnecting the ends with a sufficient radius to surround the roots of the plant and securing the ends together; 3) digging a hole of a type chosen from the group consisting of a hole of sufficient to diameter and depth to accommodate the roots of the plant surrounded by the edge strip for new plants and a circular trench of sufficient to diameter and depth to accommodate the edge strip around existing plants; 4) placing the edge strip in the hole around the roots of the plant with an upper edge thereof approximately flush with an upper surface of the ground; and 5) filling in the hole around the roots and the edge strip to anchor them in the ground so the edge strip blocks the roots of the plant and the roots of surrounding plants from mixing together.

The method preferably further includes: 1) a step of cutting the edge strip to length; 6) wherein the ends of the edge strip provided as cut are adapted to be interconnectable to each other to form the looped configuration; 7) wherein a plurality of the edge strips are provided and the ends of adjacent edge strips are interconnected to form a longer interconnected group of multiple edge strips prior to forming the group of edge strips into the looped configuration by interconnecting remaining free ends thereof; and 8) wherein each edge strip provided includes an elongate vertical leg having the first and second ends and a pair of elongate horizontal flanges that are dependent from and co-extends along respective edges of the vertical leg at right angle thereto, each divided into a plurality of individual tabs separated by respective slots adapted to facilitate bending of the edge strip.

The edge strips are preferably made using a manufacturing method of the present invention wherein the edge strips are extruded as a raw edge strip from plastic, cut to raw lengths, several raw lengths placed in a holding fixture, and the raw lengths are cut to the finished configuration using a water-jet cutting machine. Such water-jet cutting machines are used in industry to cut metal parts, but I have found them highly suitable in the present invention. The method particularly eliminates the tedious requirement of measuring and marking the location of each slot on each raw length of raw edge strip and subsequent cutting using a band saw or similar mechanical device.

An exemplary method for manufacturing plastic parts for low cost, and in particular the edge strips uses appropriate fixturing and water-jet or similar liquid abrasive cutting process. The method includes the steps of: 1) providing a fixture for holding at least one raw length of extruded raw edge strip to be cut; 2) cutting extruded raw edge strip into the raw lengths; 3) assembling at least one raw lengths of edge strip to the fixture; 4) manually or automatically cutting one or more fixtured edge strips to finished form using a water-jet machine; and 5) removing the finished edge strip or strips from the fixture.

The method may be manually operated wherein the cutting head is manually moved by hand to various stop positions to cut the tabs, a fully automated computer numerical controlled (CNC) machine or something in-between. The method can include extruding of the raw edge strip from plastic and cutting to raw lengths using a water-jet machine or other suitable cutting machine. Granular abrasive material may be used in the water jet if desired. Preferably, the fixture is designed such that multiple raw lengths of the raw edge strip are simultaneously cut, such as where the fixture retains the lengths of raw edge strip in a stacked configuration with the cutting water jet disposed perpendicular to the vertical legs thereof.

A preferred method of manufacturing plastic edge strips includes the steps of: 1) cutting, extruded raw edge strip into the raw lengths of edge strip; 2) providing a fixture for holding at least one of the raw lengths of edge strip; 3) assembling at least one of the raw lengths of edge strip to the fixture; 4) cutting each raw length of edge strip in the fixture to a finished form; and 5) removing each raw length of edge strip in finished form from the fixture.

The method preferably is done wherein: 6) the raw lengths of edge strip are cut to the finished form using a process chosen from the group consisting of liquid abrasive jet cutting and milling; 7) the process used simultaneously makes multiple cuttings to each of the raw lengths of the edge strip to the finished form using multiple cutting heads; 8) the cutting process is done in a manner chosen from the group consisting of manually operated wherein one or more cutting heads is manually moved by hand to various stop positions, fully automated computer numerical controlled machines, and semi-automatic machines; and 9) the fixture holds a plurality of the raw lengths of edge strip for simultaneous cutting to final form.

The edge strip 20 is a unique precision manufactured landscape border, edging product that can be utilized in a wide variety of custom design applications. It is constructed of a sturdy, lightweight polyvinyl chloride plastic channel that is impervious to weathering, heaving and is virtually unbreakable.

The edge strip 20 is a non-biodegradable containment ring to be used in a home garden environment. Installing the edge strip 20 around your prized roses or other favorite landscape centerpieces provides the following benefits: 1) forms a “virtual landscape pot”; 2) controlled watering; 3) controlled fertilization; 4) controlled mulching; 5) controlled rhizomes growth; 6) easier weed control; 7) more vibrant growth; 8) no more seasonal heaving; and 9) virtually break and fraction free.

The edge strip's specially constructed 5½ inch deep channel creates a custom “Virtual Landscape Pot” that helps contain the vital nutrients and help eliminate nature's nuisances. Your roses and other specimen plants or shrubs will enjoy a healthier seasonal growth and help provide a truly prized landscape.

The majority of landscape bordering and edging products on the market today suffer from one glaring deficiency that they tend to heave or exhibit fracturing after only one or two seasonal cycles. This requires border or edging maintenance. The ¾ inch lip acts as a more permanent built-in anti-heaving feature. Each 51 inch length is constructed of sturdy polyvinyl chloride (PVC) plastic that is virtually unbreakable, meaning that once in place, it requires no maintenance for many years.

The edge strips 20 may be utilized as a continuous border or edging, being extraordinarily flexible and durable and with the interlocking ends to create an unlimited border or edge. Customize your flower beds, create isolated islands of normally invasive perennials. The depth and anti-heaving characteristics control many of the most adventurous bedding plants. Rhizomes have less of a chance to spread, being unable to penetrate the 5½ inch deep barrier.

As can be seen in the description above, the edging device satisfies all of the shortcomings of the prior art edging devices including: 1) being designed to conform to both straight and curved boundaries between landscaping areas including encircling individual or small groups of plants and being securable in a looped configuration; 2) being of a relatively simple, single-piece design that is readily manufacturable using inexpensive processes such as extrusion; 3) is minimally obtrusive with virtually no protrusion above the surface of the ground; and 4) resists breakage and distortion due to heaving of the ground.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

I claim:

1. A flexible edge strip for insertion into the ground around plants to prevent roots of the plant and the roots of surrounding plants from mixing together, comprising:
an elongate, flexible vertical leg having respective first and second ends adapted to be interconnectable to each other to form a looped configuration and to adjacent edge strips to form a longer interconnected group configuration of multiple edge strips;
at least one elongate horizontal flange that is dependent from and co-extends along said vertical leg at an angle thereto which is divided into a plurality of individual tabs separated by respective slots adapted to facilitate bending of the edge strip; and
wherein said vertical leg functions to obstruct water outflow and root growth when inserted into the ground generally parallel to a surface thereof and said horizontal flange is adapted to perform a function chosen from the group consisting of obstructing plant growth above the ground and anchoring the edge strip within the ground.

2. The edge strip according to claim 1, wherein the vertical leg has respective top and bottom edges with each horizontal flange respectively dependent along one thereof.

3. The edge strip according to claim 2, wherein the slots each have respective straight portions through the horizontal flange terminating at respective round ends through the vertical leg adapted to relieve stresses to prevent cracking of said vertical leg.

4. The edge strip according to claim 2, wherein there are a pair of the horizontal flanges to form a C-shaped cross-section.

5. The edge strip according to claim 1, wherein the vertical leg has a height of between about five and six inches and each horizontal flange is of a width of between about one-half inch and one inch.

6. The edge strip according to claim 1, wherein the vertical leg and horizontal flanges are of a substantially equal constant thickness.

7. The edge strip according to claim 7, wherein the thickness of the horizontal and vertical legs is between about one-sixteenth inch and one-quarter inch.

8. The edge strip according to claim 1, wherein the vertical leg and horizontal flanges are integrally molded from a plastic material chosen from the group consisting of polyvinyl chloride, polyethylene, and polypropylene.

9. The edge strip according to claim 8, wherein the edge strip is initially extruded from the plastic material and then cut to final shape.

10. The edge strip according to claim 1, wherein each horizontal flange co-extends along the vertical leg at substantially a right angle thereto.

11. The edge strip according to claim 1, wherein the first end of the vertical leg has a T-shaped retaining tab comprised of a vertically disposed end leg and an intersecting horizontally disposed longitudinal leg, and the second end thereof has a vertically disposed retaining slot adapted to receive said retaining tab therethrough to vertically and longitudinally retain said retaining tab therein.

12. The edge strip according to claim 11, wherein the retaining slot is of a length slightly smaller than the end leg requiring slight tilting of said retaining tab for insertion therethrough.

13. The edge strip according to claim 12, wherein the vertical leg has longitudinally angled edges which extend from said longitudinal leg to facilitate the tilting of said retaining tab for insertion through the retaining slot.

14. The edge strip according to claim 13, wherein the vertical leg has respective cutouts to further facilitate tilting of the retaining tab for insertion through the retaining slot.

15. The edge strip according to claim 1, wherein the first end of the vertical leg has a retaining tab, and the second end thereof has a vertically disposed retaining slot adapted to receive said retaining tab therethrough to vertically retain said retaining tab therein.

16. The edge strip according to claim 15, wherein the retaining tab is longitudinally tapered and the retaining slot is of a length slightly larger than a maximum height of said retaining tab to allow complete insertion thereof into said retaining slot.

17. The edge strip according to claim 1, wherein at least one separation line extends generally transversely across the vertical leg and horizontal flanges for shortening of the edge strip to at least one predetermined shorter length.

18. The edge strip according to claim 17, wherein an area adjacent each separation line comprises a new second end adapted to be interconnectable to the first end of the vertical wall for retention of the shortened edge strip in the looped configuration.

19. The edge strip according to claim 17, wherein each separation line extends substantially at a right angle transversely across the edge strip.

20. The edge strip according to claim 17, wherein each separation line is of a configuration chosen from the group consisting of printed for cutting, perforated for breaking, reduced thickness for breaking, and unmarked for cutting.

21. The edge strip according to claim 17, wherein each separation line extends from respective of the slots between the retaining tabs across the vertical wall.

22. The edge strip according to claim 1, wherein the vertical leg has respective top and bottom edges with each horizontal flange respectively dependent along one thereof, there being a pair of said horizontal flanges to form a C-shaped cross-section with each horizontal flange co-extending along the vertical leg at substantially a right angle thereto, the first end of the vertical leg having a retaining tab of a type chosen from the group consisting of a T-shaped retaining tab and a longitudinally tapered retaining tab each adapted for insertion through a vertically disposed retaining slot of the second end adapted to receive said retaining tab therethrough to retain said retaining tab therein, said T-shaped retaining tab being comprised of a vertically disposed end leg and an intersecting horizontally disposed longitudinal leg, said retaining slot being of a length slightly smaller than said end leg requiring slight tilting of said retaining tab for insertion therethrough, said vertical leg having longitudinally angled edges which extend from said longitudinal leg to facilitate the tilting of said retaining tab for insertion through said retaining slot, and with said longitudinally tapered retaining tab said retaining slot being of a length slightly larger than a maximum height of said tapered retaining tab to allow complete insertion thereof into said retaining slot, and at least one separation line extending generally transversely across said vertical leg and said horizontal flanges for shortening of the edge strip to at least one predetermined shorter length, an area adjacent each separation line comprising a new second end adapted to be interconnectable to said first end of said vertical wall for retention of the shortened edge strip in the looped configuration, each separation line extending substantially at a right angle transversely across the edge strip and being of a configuration chosen from the group consisting of printed for cutting, perforated for breaking, reduced thickness for breaking, and unmarked for cutting, with each separation line extending from respective of the slots between the retaining tabs across said vertical wall.

23. The edge strip according to claim 22, wherein the vertical leg has a height of between about five and six inches and each horizontal flange is of a width of between about one-half inch and one inch, said vertical leg and horizontal flanges are of a substantially equal constant thickness of between about one-sixteenth inch and one-quarter inch, being initially extruded from the plastic material and then cut to final shape, and said vertical leg having respective cutouts to further facilitate tilting of the retaining tab for insertion through the retaining slot.

24. A method of preventing roots of plants and the roots of surrounding plants from mixing together, comprising the steps of:
providing a flexible edge strip having opposite ends adapted to be interconnectable to each other;
forming the edge strip into a looped configuration by interconnecting the ends with a sufficient radius to surround the roots of the plant and securing the ends together;
digging a hole of a type chosen from the group consisting of a hole of sufficient to diameter and depth to accommodate the roots of the plant surrounded by the edge strip for new plants and a circular trench of sufficient to diameter and depth to accommodate the edge strip around existing plants;
placing the edge strip in the hole around the roots of the plant with an upper edge thereof approximately flush with an upper surface of the ground; and
filling in the hole around the roots and the edge strip to anchor them in the ground so the edge strip blocks the roots of the plant and the roots of surrounding plants from mixing together.

25. The method according to claim 24, further comprising the step of:
cutting the edge strip to length; and
wherein the ends of the edge strip provided as cut are adapted to be interconnectable to each other to form the looped configuration.

26. The method according to claim 24, wherein a plurality of the edge strips are provided and the ends of adjacent edge strips are interconnected to form a longer interconnected group of multiple edge strips prior to forming the group of edge strips into the looped configuration by interconnecting remaining free ends thereof.

27. The method according to claim 24, wherein each edge strip provided includes an elongate vertical leg having the first and second ends and a pair of elongate horizontal flanges that are dependent from and co-extends along respective edges of the vertical leg at right angle thereto, each divided into a plurality of individual tabs separated by respective slots adapted to facilitate bending of the edge strip.

28. A method of manufacturing plastic edge strips, comprising the steps of:
cutting extruded raw edge strip into the raw lengths of edge strip;
providing a fixture for holding at least one of the raw lengths of edge strip;
assembling at least one of the raw lengths of edge strip to the fixture;
cutting each raw length of edge strip in the fixture to a finished form; and
removing each raw length of edge strip in finished form from the fixture.

29. The method according to claim 28, wherein the raw lengths of edge strip are cut to the finished form using a process chosen from the group consisting of liquid abrasive jet cutting and milling.

30. The method according to claim 29, wherein the process used simultaneously makes multiple cuttings to each of the raw lengths of the edge strip to the finished form using multiple cutting heads.

31. The method according to claim 29, wherein the cutting process is done in a manner chosen from the group consisting of manually operated wherein one or more cutting heads is manually moved by hand to various stop positions, fully automated computer numerical controlled machines, and semi-automatic machines.

32. The method according to claim 29, wherein the fixture holds a plurality of the raw lengths of edge strip for simultaneous cutting to final form.
